(19) United States
(12) Patent Application Publication
(10) Pub. No.: US 2025/0086698 A1
(43) Pub. Date: Mar. 13, 2025

(54) Browser Scraping-Based Auction Transaction Association System

(71) Applicant: Capital One Services, LLC, McLean, VA (US)

(72) Inventors: Joshua Edwards, Philadelphia, PA (US); Michael Mossoba, Great Falls, VA (US); Tyler Maiman, Melville, NY (US)

(73) Assignee: Capital One Services, LLC, McLean, VA (US)

(21) Appl. No.: 18/244,667

(22) Filed: Sep. 11, 2023

(51) Int. Cl. G06Q 30/08

(52) U.S. Cl. CPC G06Q 30/08

(57) ABSTRACT

Methods, systems, and apparatuses are described herein for associating past auction bidding activity with subsequent financial transactions. A computing device may receive, from a web browser plugin of a web browser application executing on a user computing device, bid information relating to bids placed by a user on an auction website. Such information may be collected by, for example, scraping the Document Object Model of the website. After the auction ends, the computing device may determine a plurality of different candidate financial transactions for the user. Based on an estimated payment amount, the computing device may select, from the plurality of different candidate financial transactions, a matching financial transaction, then output an association between a bid and the matching financial transaction.

### FIELD OF USE

Aspects of the disclosure relate generally to browser scraping and website-based transactions. More specifically, aspects of the disclosure may provide for monitoring of web browser activity and use of such monitoring to associate past online auction bidding activity with subsequent financial transactions.

### BACKGROUND

Many users place bids on auctions conducted via online websites. For example, the website eBay.com, owned by eBay Inc. of San Jose, California, allows users to bid on various auctions for goods online. Similar auctions are offered on the website Mercari.com, owned by Mercari, Inc. of Tokyo, Japan. Broadly, such auctions operate by allowing users to log in, browse for item(s) of interest, bid on those items (usually by placing a maximum bid amount), and pay for those items (including paying appropriate tax and shipping fees) after the auction has ended. With these systems, a user usually only pays for an item if they place the winning bid in the auction. Moreover, users typically do not actually pay for a particular auction unless they win, meaning that a user's bid might be placed hours (if not days or weeks) before the user actually pays for a particular auction item.

Because a user might pay for an item long after they placed a bid, and because users generally pay for items through an auction website (rather than directly to a seller on the auction website), it can be difficult for users to correlate payments with the items they purchased via auction. For example, if an avid baseball card collector regularly bids on and wins auctions for baseball cards costing around five to ten dollars, it might be difficult for the baseball card collector to determine which particular transactions on their credit card statement correlate to a particular baseball card that they won via auction. After all, the avid baseball collector might have hundreds of different charges to eBay.com, but might not know which charge correlates to which particular auction.

Aspects described herein may address these and other problems, and generally improve the process via which data regarding transactions is provided by scraping web browser information and using that information to associate past auction bidding activity with subsequent financial transactions.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein use Document Object Model (DOM) scraping techniques to capture information about online auction bidding activity and use that information to later correlate subsequent financial transactions with past auction bidding activity. As will be described further below, a web browser plugin of a web browser application executing on a user computing device may be configured to collect (e.g., scrape) information from a DOM of an auction website displayed by the web browser. Such functionality may capture, for example, an auction bid amount, auction end time, one or more item identifiers, a username of the user, and/or the like. This information may be transmitted to a remote server. The remote server may then, after the auction end time has elapsed (and/or after detecting a financial transaction with the merchant), determine whether a candidate financial transaction of a plurality of different candidate financial transactions corresponds to a winning bid. The remote server may perform this process by estimating an estimated payment amount (based on, e.g., how much the user bid, estimated shipping and tax, and the like) and comparing that estimated payment amount to one or more candidate financial transactions. The remote server may also perform this process by retrieving information from the auction website, such as by evaluating whether the auction website indicates a winner of an auction and whether that winner corresponds to a username of a particular user. If a financial transaction is determined to be associated with the auction, then one or more items of the auction may be associated with the financial transaction. For example, a user interface may be displayed that indicates an association between a particular financial transaction and the auction.

More particularly, some aspects described herein may provide for a computing device configured to associate past auction bidding activity with subsequent financial transactions. The computing device may receive, from a web browser plugin of a web browser application executing on a user computing device and via a network, at least a portion of content displayed via a Document Object Model (DOM) of the web browser executing on the user computing device. That content may be associated with an auction website. The computing device may process the content displayed via the DOM to determine bid information indicating a first bid placed by a user on a first auction on the auction website. The bid information may comprise, among other things, an auction end time, a bid amount, and/or one or more item identifiers. The computing device may, after the auction end time has elapsed, determine, via the auction website, auction information that indicates a winning bid amount for the first auction. For instance, the computing device may determine, via the auction website, that a username associated with the user is indicated as winning the auction. The computing device may receive, from a transactions history database and based on the auction end time, a plurality of different candidate financial transactions conducted by a financial account associated with the user. The computing device may receive account data, associated with the financial account, that indicates a location associated with the user. The computing device may determine an estimated payment amount based on the bid amount and predicted shipping costs associated with the location. The estimated payment amount may be further based on tax information corresponding to the location. The computing device may then select, based on the winning bid amount and based on comparing the estimated payment amount to each transaction amount of the plurality of different candidate financial transactions, a first financial transaction of the plurality of different candidate financial transactions. Then, the computing device may output, in a user interface, an association between the first bid and the first financial transaction. For example, the computing device may output, in the user interface, at least a portion of the one or more item identifiers.

Selecting the financial transaction may be performed using a number of different approaches. For example, the computing device may determine that a difference between a first transaction amount associated with the first financial transaction and the estimated payment amount satisfies a threshold. As another example, the computing device may determine that the first financial transaction indicates a merchant associated with the auction website. As another example, the computing device may determine, based on the auction end time, a predicted payment time associated with the first bid and filter, based on the predicted payment time, the plurality of different candidate financial transactions. As yet another example, the computing device may determine that a first transaction amount associated with the first financial transaction is lower than the maximum bid amount.

As will be detailed below, not all bids might be found to correlate to a particular transaction. For example, the computing device may determine, based on comparing a second estimated payment amount associated with a second bid to each transaction amount of the plurality of different candidate financial transactions, that the second bid is not associated with any of the plurality of different candidate financial transactions. In such a circumstance, the computing device may delete, from storage, second bid information associated with the second bid.

Corresponding method, apparatus, systems, and non-transitory computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure:

FIG. 3 depicts a system comprising different computing devices that may be used in implementing one or more aspects of the disclosure in accordance with one or more illustrative aspects discussed herein:

FIG. 4A depicts an auction bidding webpage:

FIG. 4B depicts an auction results webpage; and

FIG. 5 depicts a flow chart comprising steps which may be performed for associating past auction bidding activity with subsequent financial transactions.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for using bidding information collected via web browser DOM scraping to determine bidding information that can be used to associate past bidding activity with subsequent financial transactions. Presently, financial transactions that indicate payments to online auction platforms, such as auction websites, do not indicate the particularities of the bid placed by a user. For example, a credit card transaction history might indicate that a user paid ten dollars to eBay.com, but might not indicate what the transaction was for (e.g., what auction was won by the user, which item(s) were purchased, the identity of the seller, or the like). Aspects described herein remedy this problem by using a web browser plugin to collect bidding information from the DOM of a web browser when, for example, a user places a bid on an auction website. That information is then used to correlate the user's bidding activity with subsequent financial transactions, even when those subsequent financial transactions occur hours, days, or even weeks after the original bid. For example, the information from the DOM might be processed to identify an auction end time, a bid amount, and/or one or more item identifiers. Then, after the auction end time (and/or after detecting a financial transaction with an auction website), a server might determine a wining bid amount, candidate financial transactions that might be associated with the auction, and an estimated payment amount that estimates how much a user spent (including, e.g., the user's original bid(s), the predicting shipping costs, and/or applicable tax). Then, the server might select one of the candidate financial transactions. Based on that selection, the server might display, in a user interface, an association between the selected one of the candidate financial transactions and, for instance, one or more items purchased in the auction.

As an example of how the present disclosure may operate, a user might, on a Monday evening, bid on a baseball card auction on an auction website. As part of that process, the user might indicate a fifty dollar maximum bid. When the user places the bid, a web browser plugin of a web browser application executing on the user's computing device might, by collecting information via the DOM of the web browser application, collect information such as an auction end time (e.g., Tuesday evening), a bid amount (e.g., the fifty dollar maximum bid), and one or more item identifiers (e.g., an identifier of the baseball card). That information may be provided to, and processed by, a remote server. After the auction end time has elapsed (e.g., after Tuesday evening), and/or upon detecting a particular financial transaction (e.g., upon detecting a financial transaction with the auction website), the server may determine, by querying the auction website (if possible), a winning bid amount for the auction (e.g., thirty dollars). The server may also determine a plurality of different candidate financial transactions that might be associated with payment for the auction. For example, the server might identify that the user made three payments to the auction website: one for ten dollars, another for forty-six dollars, and another for eighty dollars. The server might also determine an estimated payment amount based on the bid amount (e.g., the fifty dollar maximum bid), predicting shipping costs associated with a location of the user (e.g., ten dollars), and/or tax information (e.g., five dollars). The server might then select one of the plurality of different candidate financial transactions by recognizing that the most likely transaction corresponding to the baseball card bid is the forty-six dollar transaction (particularly since the winning bid was thirty dollars, shipping was ten dollars, and tax was five dollars). The server may then, in turn, output a user interface indicating a correlation between the forty-six-dollar transaction and the baseball card.

Aspects described herein improve the functioning of computers by improving the manner with which computers collect, process, and associate data. The present disclosure leverages web browser plugin-based DOM scraping to collect information far in advance of subsequent transactions, such that the information might be later associated. This significantly expedites alternative processes via which this association might be generated. For example, rather than forcing users to manually indicate which transactions are associated with certain bids, the present system automates this process through web browser plugin-based DOM scraping. As another example, this process enables associations between transactions and bids even when auction website owners do not (for security or other reasons) provide direct access to auction information. The aspects described herein are also a unique and practical implementation of the basic concepts underpinning auctions. The present disclosure is not related to auctions, the basic idea of financial transactions, or the like. To the contrary, the present disclosure describes a system that leverages DOM scraping to correlate otherwise unrelated portions of data to provide better insights into past auction activity. The present disclosure could not be performed by a human being and/or with pen-and-paper at least because the present disclosure is fundamentally rooted in technology such as web browser plugins, DOM scraping, and the like.

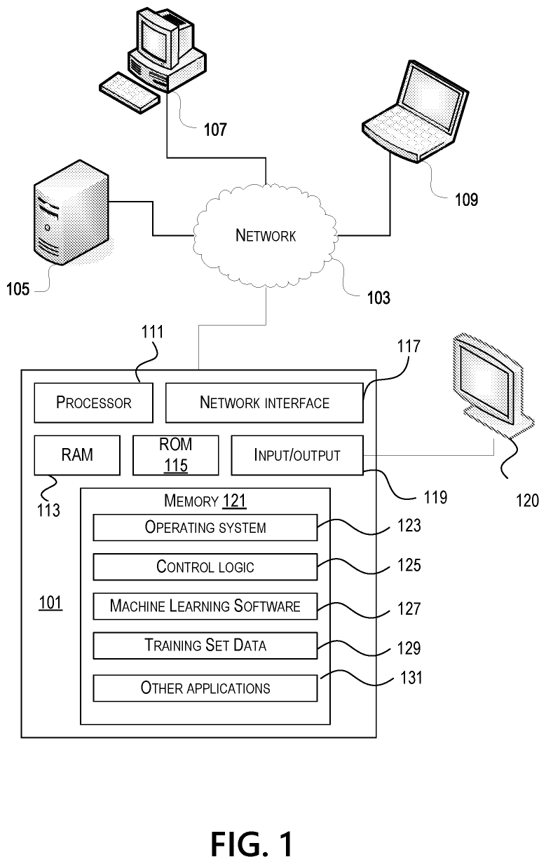

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, training set data 129, and other applications 131. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

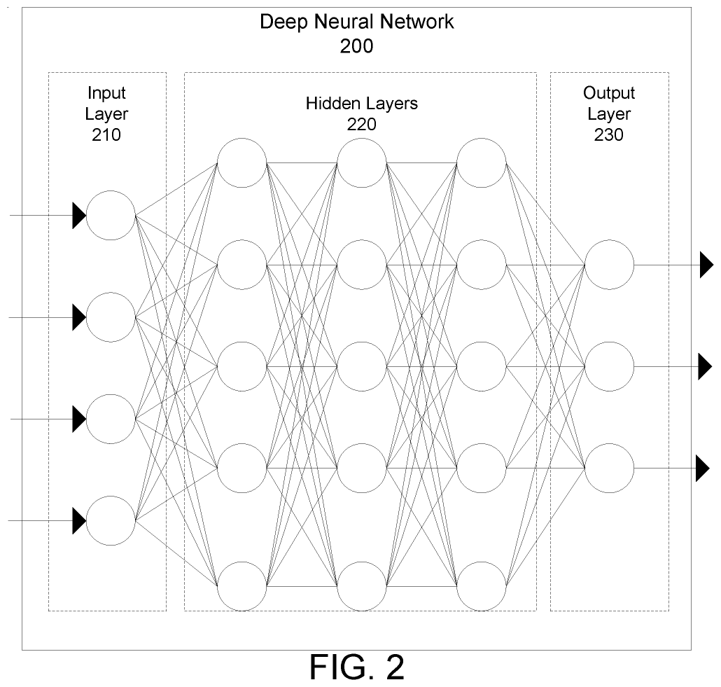

FIG. 2 illustrates an example deep neural network architecture 200. Such a deep neural network architecture may be all or portions of the machine learning software 127 shown in FIG. 1. That said, the architecture depicted in FIG. 2 need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220), and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

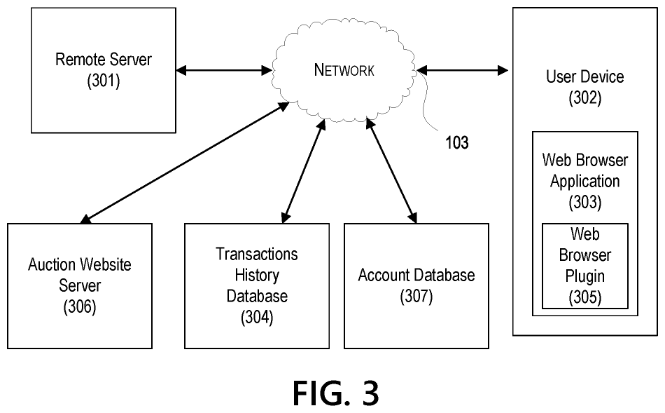

FIG. 3 depicts a system for associating information collected from a DOM of a web browser during auction bidding with subsequent transactions. The system comprises a remote server 301 that is communicatively coupled, via a network 103, to a user device 302. The user device 302 may execute a web browser application 303. The web browser application 303 may comprise a web browser plugin 305. The remote server 301 may further be communicatively coupled, via the network 103, to an auction website server 306, a transactions history database 304, and/or an account database 307. Any of the elements depicted in FIG. 3 may comprise one or more computing devices, such as one or more computing devices comprising one or more processors and memory that, when executed by the one or more processors, cause the performance of one or more steps. Additionally and/or alternatively, any of the elements depicted in FIG. 3 may be implemented via non-transitory computer-readable media storing instructions that, when executed by a computing device, cause the performance of one or more steps.

The remote server 301 may comprise one or more computing devices configured to associate past auction bidding activity with subsequent financial transactions. The remote server 301 may be configured to receive bid information from the user device 302. For example, the remote server 301 may be configured to receive, from the user device 302, information, collected via a DOM of the web browser application 303 via the web browser plugin 305, that indicates an auction end time, a bid amount, and/or one or more item identifiers associated with an auction. The remote server 301 may be configured to receive, from the auction website server 306, information such as a winning bid amount, an auction end time, and/or a winning bid user account. The remote server 301 may be configured to receive, from the transactions history database 304, transactions information, such as indications of one or more transactions conducted by one or more users. The remote server 301 may be configured to receive, from the account database 307, information such as a location (e.g., a physical mailing address) associated with a user, one or more user accounts associated with the user, and/or tax information corresponding to the location of the user (e.g., whether the user is subject to sales tax for certain items, like clothing).

The remote server 301 may be configured to process messages (e.g., e-mails, text messages, push messages) to evaluate bid information and/or auction information. For example, if a user provides the remote server 301 credentials for their e-mail account, the remote server 301 may be configured to periodically scan that user's e-mails to determine information about auctions and bids placed on those auctions. Such scanning may entail the same or similar processes performed by the web browser plugin 305, such as use of natural language processing algorithms. As such, the remote server 301 may be configured to determine all or portions of bid information and/or auction information based on the processing of messages associated with a user.

The user device 302 may comprise any computing device that may execute the web browser application 303 and may be used to participate in auctions on online auction websites. For example, the user device 302 may comprise a desktop, laptop, smartphone, tablet computer, or the like. The user device 302 might be capable of communicating, via the network 103, with one or more servers associated with one or more websites, such as one or more auction websites. For example, the user device 302 may be capable of accessing, via the network 103 and using the web browser application 303, one or more auction websites.

The web browser plugin 305 may be any plugin or similar modification to the web browser application 303 that configures the web browser application 303 to collect bid information from an auction website. For example, the web browser plugin 305 may be configured to, in response to detecting that the web browser application 303 is accessing a Uniform Resource Locator (URL) associated with an auction website, process the DOM of the web browser application 303 to identify bid information corresponding to one or more bids placed by a user. To perform this identification, the web browser plugin 305 may use XPath, regular expressions, or similar techniques to search for content in portions of a displayed web page. For example, the web browser plugin 305 may be configured with information that allows it to identify, in a web page, which form(s) in the web page contain bid amount content, such that-if a user enters content into those form(s)—the web browser plugin 305 can capture and store that content. As another example, the web browser plugin 305 may be configured with information that allows it to identify, in a web page, which HyperText Markup Language (HTML) portions of a web page indicate an auction bid time and/or items involved in the auction, such that the web browser plugin 305 can scrape and store information associated with the auction bid time and/or the items involved in the auction.

The web browser plugin 305 may additionally and/or alternatively be configured to process user messages to determine bid information and/or auction information. For example, in addition to being configured to collect bid information from an auction website, the web browser plugin 305 may be configured to process messaging data when a user accesses (e.g., via the web browser application 303) a website, such as an online mail website, that provides messaging information. For example, the web browser plugin 305 may be configured to process an e-mail received from an auction website to determine, based on the content of that e-mail, the winning bid of an auction. As another example, the web browser plugin 305 may be configured to process an e-mail received from an auction website to determine, based on the content of that e-mail, the amounts of various bids placed by a user and/or whether a user has paid after winning an auction. In this manner, the web browser plugin 305 may be configured to collect bid information and/or auction information from not only the auction website, but also by processing messages (e.g., those reflected in an online interface, such as an online mail website, an online chat application, or the like).

For privacy purposes, the web browser plugin 305 may be configured to capture content from the DOM only under certain conditions. For example, the web browser plugin 305 may be configured to only capture content when the web browser application 303 is accessing particular URLs, such as those associated with an auction website.

The auction website server 306 may be a server that provides all or portions of an auction website. Such a website may, in response to requests for a web page (e.g., from the web browser application 303 of the user device 302), provide content such as HTML, one or more media elements (e.g., images, audio), or the like. The auction website server 306 may provide access to one or more web pages, such as an auction bidding webpage (via which users might place a bid), an auction results website (via which information about the winner of an auction might be collected), and the like. The auction website server 306 may be configured to transmit messages to a user based on auction activity. For example, the auction website server 306 may be configured to transmit an e-mail to a user when the user places a bid, when the user is no longer the winning bid, when the auction closes (whether or not the user wins the auction), when the user pays after winning the auction, and the like.

The transactions history database 304 may be configured to store information relating to one or more transactions conducted by one or more users. For example, the transactions history database 304 may store a list of one or more transactions made by one or more users via a credit card, debit card, checking account, online payment account, or the like. The transactions history database might, for each transaction, store information such a merchant involved in the transaction, an amount of the transaction, a date and/or time of the transaction, and the like.

The account database 307 may be configured to store information about one or more user accounts. For example, the account database 307 may store information such as one or more usernames associated with a user, a location (e.g., a physical mailing address, a street address, a city) associated with the user, tax information associated with the user (e.g., which taxes are applicable to a user based on their location), and the like.

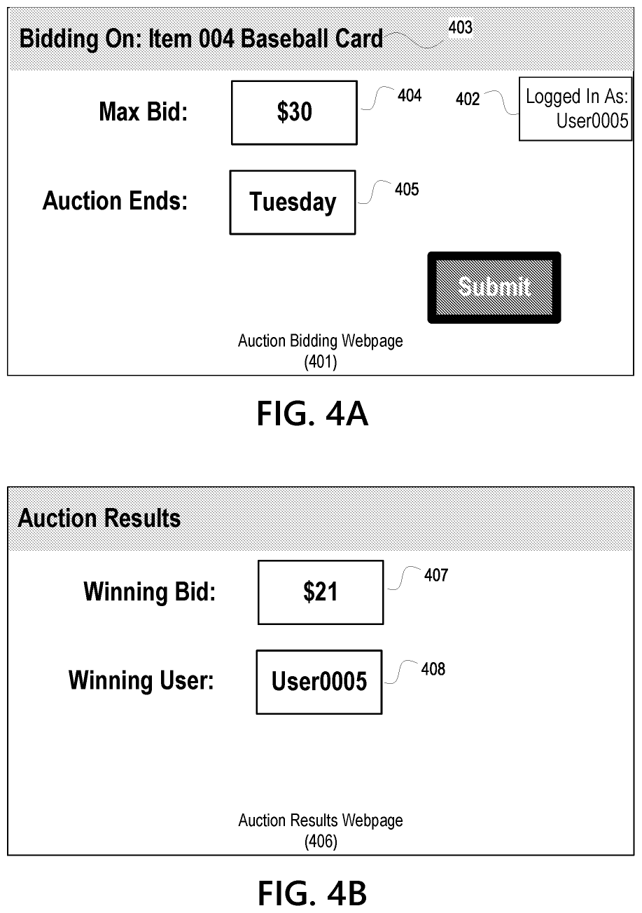

FIG. 4A depicts an auction bidding webpage 401 which might be provided by the auction website server 306. The auction bidding webpage 401 comprises an item identifier 403, a maximum bid 404, a logged in user indication 402, and an auction end time 405. Specifically, the item identifier 403 shows that a user is bidding on “Item 004 Baseball Card,” the maximum bid 404 is thirty dollars, the logged in user indication 402 indicates that “User0005” is logged in, and the auction end time 405 shows that the auction ends on Tuesday. The information depicted in the auction bidding webpage 401 is illustrative, and a variety of different auction websites may be configured differently. For example, some auction websites might hide the auction end time 405, whereas others might only allow entry of the maximum bid 404 in predetermined increments (e.g., five-dollar increments).

FIG. 4B depicts an auction results webpage 406 which might be provided by the auction website server 306. The auction results webpage 406 comprises an indication of a winning bid amount 407 and an indication of a winning user 408. Specifically, the indication of the winning bid amount 407 indicates that the wining bid was twenty-one dollars, whereas the indication of the winning user 408 indicates that the winning user is “User0005.”

A web browser plugin, such as the web browser plugin 305, may be configured to process webpages like the auction bidding webpage 401 and the auction results webpage 406 to determine bid information and auction information. For example, the web browser plugin 305 may be configured to monitor, via JavaScript or the like, user entry provided to the auction bidding webpage 401 to determine the maximum bid 404, the auction end time 405, the item identifier 403, and/or the logged in user indication 402. As another example, the web browser plugin 305 may be configured to scrape the HTML of the auction results webpage 406 to identify the indication of the winning bid amount 407 and/or the indication of the winning user 408.

Comparison of the auction results webpage 406 and the auction bidding webpage 401 indicates why it may be difficult for a user to readily associate a subsequent financial transaction with past bidding activity. In the circumstance depicted in FIG. 4A and FIG. 4B, a user wins an auction and pays twenty-one dollars despite having bid up to thirty dollars. In such a circumstance, the total transaction amount for such a purchase, even including shipping and tax costs, might be different than thirty dollars. As a result, a user might not readily recognize that, for instance, a subsequent financial transaction for twenty-eight dollars in fact corresponds to their past thirty-dollar bid. The methods described herein address this issue by associating such a transaction with the bidding activity.

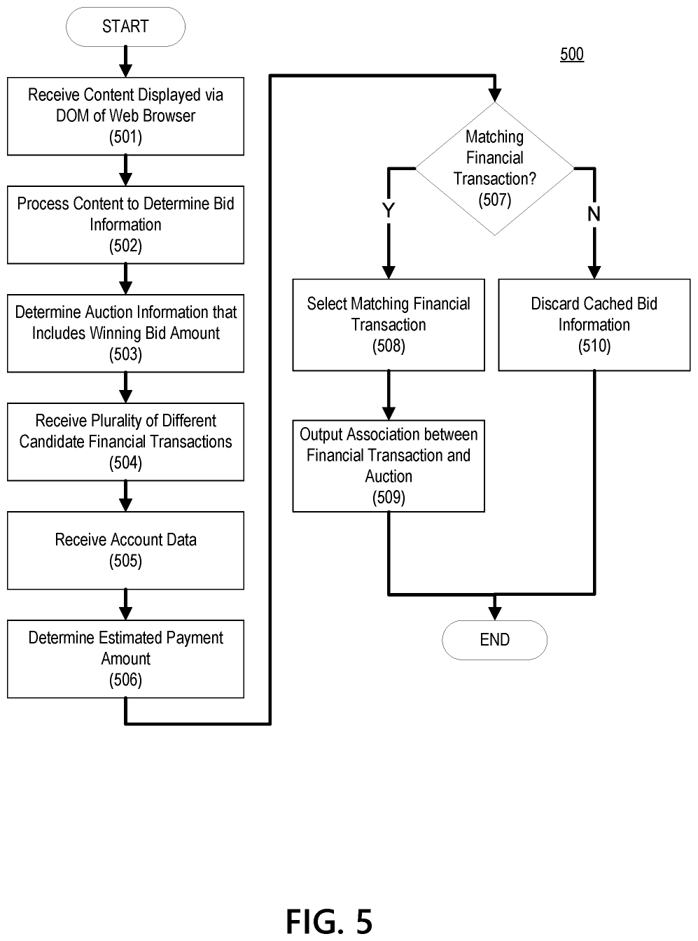

FIG. 5 illustrates an example method 500 for associating past auction bidding with subsequent financial transactions in accordance with one or more aspects described herein. The method 500 may be implemented by a suitable computing system, as described further herein. For example, the method 500 may be implemented by any suitable computing environment by a computing device and/or combination of computing devices, such as one or more of the computing devices 101, 105, 107, and 109 of FIG. 1, the remote server 301, and/or any computing device comprising one or more processors and memory storing instructions that, when executed by the one or more processors, cause the performance of one or more of the steps of FIG. 5. The method 500 may be implemented in suitable program instructions, such as in machine learning software 127, and may operate on a suitable training set, such as training set data 129. The method 500 may be implemented by one or more non-transitory computer-readable media that stores instructions that, when executed, cause performance of all or portions of the method 500. The steps shown in the method 500 are illustrative, and may be re-arranged or otherwise modified as desired.

In step 501, the computing device may receive, from a user device such as the user device 302, content displayed via a DOM of the web browser. This step may entail receipt of information relating to an auction website from a web browser plugin, such as the web browser plugin 305 of the web browser application 303. For example, the computing device may receive, from a web browser plugin of a web browser application executing on a user computing device and via a network, at least a portion of content displayed via a DOM of the web browser executing on the user computing device. The information received from the web browser plugin may be in a variety of formats. For example, the information may comprise all HTML data from the DOM of the web browser. As another example, the information may comprise a processed form of content from the DOM, such as an indication of an auction end time, a bid amount, and/or one or more item identifiers.

In step 502, the computing device may process the content to determine bid information. Processing the content may comprise identifying elements in the content. For example, processing the content may comprise using XPath, regular expressions, or similar strategies for identifying specific elements of the content. As another example, the computing device may process the content displayed via the DOM to determine bid information indicating a first bid placed by a user on a first auction on the auction website. The bid information may include a variety of information relating to a bid placed by a user. The bid information may comprise an auction end time. The auction end time may indicate a time and/or date when a particular auction is scheduled to end. The bid information may comprise a bid amount. The bid amount may indicate one or more item identifiers. The one or more item identifiers may comprise item names, item photos, item descriptions, item codes, or similar details which may be used to identify one or more items involved in an auction.

The bid information may indicate multiple bids and/or whether a user has been outbid. In the case of multiple bids, the bid information may be filtered to reflect the latest (and, generally, the highest) maximum bid of a user. In the case where a user has been outbid, if the user does not initiate a higher bid, then the process depicted in FIG. 5 may end, as there may thereby be effectively no likelihood that the user will win and pay for the auction.

In some circumstances, step 502 may be performed, in whole or in part, by a user device, such that step 502 might be omitted in certain circumstances, and the receipt of information in step 501 may comprise receipt of the bid information. Which device performs step 502 (e.g., the remote server 301 versus the user device 302) may depend, in whole or in part, on processing capabilities of the user device 302. For user devices 302 with relatively greater processing power, then step 502 may be performed by the user device 302 so as to lower the amount of data transmitted, via the network 103, to the remote server 301. That said, for relatively weaker user devices 302, the processing may be performed by the remote server 301 instead.

The process described with respect to step 502 may be performed, in whole or in part, by evaluating messaging data, such as by scanning e-mails, text messages, or the like. Auction websites may send various messages (e.g., e-mails, text messages, push notifications) to auction participants. For example, an auction website might e-mail a user to confirm that a bid has been placed, to notify the user that they have been outbid, and/or to inform a user that they won or lost an auction. In turn, those messages may be processed (e.g., by the web browser plugin 305 when the web browser application 303 accesses a webmail webpage, online messaging application webpage, or the like) to determine information such as an auction end time, bid amount, item identifiers, or the like. To effectuate this process in a privacy-sensitive manner, the computing device may request and receive permission from a user to perform such scanning.

In step 503, the computing device may determine auction information. Determining the auction information may comprise determining, for instance, a winner of the auction, a winning bid amount for the auction, when the auction ended, and the like. As such, step 503 may be performed after the auction end time has elapsed. For example, the computing device may, after the auction end time has elapsed, determine, via the auction website, auction information that indicates a winning bid amount for the first auction.

As part of step 503, the computing device may determine whether the auction end time has elapsed. In some circumstances, the actual auction end time may be flexible, and/or the auction end time might not be indicated in the content received as part of step 501. In this circumstance, the computing device may configured to determine whether the auction end time has elapsed in a variety of ways. For example, the computing device may routinely access an auction results webpage (e.g., the auction results webpage 406) or a similar webpage to determine if the auction has ended.

Determining the auction information may comprise retrieving content from a server associated with the auction website, such as the auction website server 306. For example, the computing device may be configured to scrape an auction results webpage, such as the auction results webpage 406, to determine information such as a winning bid and/or a winning user. Such information may additionally and/or alternatively be collected by querying one or more servers associated with the auction website using an Application Programming Interface (API).

As part of determining the auction information, the computing device may determine the winner of an auction. This may be accomplished through scraping of an auction website, via the API, or through similar means. For example, the computing device may determine, via the auction website, that a username associated with the user is indicated as winning the auction. The winner of the auction might be associated with an account on the auction website. As such, the computing device might also determine whether the account on the auction website is associated with a particular user. This might be performed using the account database 307, as will be described below.

In some circumstances, the owner(s) of the auction website might not surface all or portions of the auction information on an auction website. For example, for privacy reasons, the auction website might not indicate which user(s) won a particular auction. As such, the auction information may be limited to information which is publicly available on the auction website and/or that which can be retrieved via an API. That said, as will be discussed below, the computing device may use whatever information available to make inferences regarding whether a particular user won an auction.

The computing device may additionally and/or alternatively determine auction information by evaluating messaging data, such as by scanning e-mails, text messages, or the like. As indicated above with respect to step 502, auction websites may send various messages (e.g., e-mails, text messages, push notifications) to auction participants. Those messages may be processed (e.g., by the web browser plugin 305 when the web browser application 303 browses a webmail page, online messaging application page, or the like) to determine auction information such as the winner of an auction.

In some circumstances, the evaluation of messaging data (e.g., as described above with respect to step 502 and/or step 503) may be performed without involvement of the web browser plugin 305. For example, a user might provide the remote server 301 permission to access their messages, such as their e-mails, text messages, chat history, or the like. In turn, the remote server 301 may periodically scan such messages for information associated with auctions, such as information about bids being placed, the winner of auctions, and the like. This process may be particularly advantageous in circumstances where, for example, a user cannot (e.g., for security reasons) execute the web browser plugin 305 on the user device 302.

In step 504, the computing device may receive, from a database such as the transactions history database 304, a plurality of different candidate financial transactions. The plurality of different candidate financial transactions may be received from one or more financial accounts associated with a particular user. For example, the computing device may receive, from a transactions history database and based on the auction end time, a plurality of different candidate financial transactions conducted by a financial account associated with the user. Such transactions may comprise, for instance, credit card transactions, debit card transactions, online payment account transactions, checking account transactions, or the like.

Where possible, the computing device might limit how many different candidate financial transactions it receives so as to minimize the processing burden of the processes depicted herein. For example, the computing device might query, from the transactions history database 304, for financial transactions within a certain timeframe (e.g., three days) of the end time of a particular auction. As another example, the computing device might query, from the transactions history database 304, for financial transactions associated with a particular merchant (e.g., a payment vendor for a certain auction website). As another example, the computing device might query, from the transactions history database 304, for financial transactions involving a payment amount within a certain range, such as no greater or less than 150% of the maximum bid amount.

In step 505, the computing device may receive, from a database such as the account database 307, account data. The account data may indicate information such as an identity of the user, a location of the user, one or more auction accounts associated with the user, or the like. For example, the computing device may receive account data, associated with the financial account, that indicates a location associated with the user. Some of this information may be retrieved via the web browser plugin 305. For example, the web browser plugin 305 may determine, by processing content via the DOM of the web browser application 303, a shipping address and/or an auction website username associated with a particular user. That information may be stored in the account database 307.

In step 506, the computing device may determine an estimated payment amount. The estimated payment amount may comprise a prediction of how much the user actually paid for the auction, which may be more or less than a maximum bid amount. This value may be based on, among other considerations, the amount of a winning bid, estimated taxes applicable to the purchase, an estimated cost for shipping to a location associated with the user, and the like. For example, the computing device may determine an estimated payment amount based on the bid amount and predicted shipping costs associated with the location.

To explain the concept of an estimated payment amount by way of example, the bid information determined in step 502 may indicate that a user placed a maximum bid of one thousand dollars on a rare video game console. The user might have ultimately won the auction for that video game console at a bid of six hundred dollars—that is, substantially less than the maximum bid. Based on the location of the user (as determined based on the account data received in step 505), the computing device might estimate shipping costs to be fifty dollars, with applicable tax being thirty dollars. As such, the estimated payment amount may be six hundred and eighty dollars, even though the maximum bid by the user was one thousand dollars. In turn, as will be detailed below, the anticipated transaction (in the plurality of different candidate financial transactions) would be approximately six hundred and eighty dollars, not one thousand dollars.

The estimated payment amount may be based on shipping information corresponding to a location. The computing device may use a location of a user (e.g., as indicated via the account data received in step 505) and properties of one or more items at auction (e.g., the items' size and/or weight) to predict shipping costs associated with a particular auction. In this manner, the estimated payment amount can reflect not merely the cost of the underlying item(s), but also the amount that the user might have paid for shipping the item(s).

The estimated payment amount may be based on tax information corresponding to a location. The computing device may use a location of a user (e.g., as indicated via the account data received in step 505) to estimate applicable taxes (if any) for the purchase of one or more items via an auction. These estimated taxes may be included in the total bid so as to accurately reflect the cost of the auction.

In certain circumstances, shipping information and/or tax information may be based on content collected by the web browser plugin 305 and received as part of step 501. For example, some auction websites publicly display estimated shipping and tax costs to a user. In turn, the web browser plugin 305 may collect this information and transmit it as part of the content received in step 501. This may advantageously make the estimated payment amount more accurate, as the shipping and tax values may be more likely to be correct (rather than, as might be the case, broad estimates based on the location of the user).

In step 507, the computing device may determine whether there is a matching financial transaction of the plurality of different candidate financial transactions. Stated differently, the computing device may determine, based on the bid information, the auction information, the account data, and/or the estimated payment amount, whether there is a financial transaction of the plurality of different candidate financial transactions that appears to be payment for the bid in the auction referenced with respect to step 502. If there is a matching financial transaction, the method 500 proceeds to step 508. Otherwise, the method 500 proceeds to step 509.

Determining whether there is a matching financial transaction may be based on the estimated payment amount. For example, an estimated payment amount of $550 may comprise the sum of a bid amount (e.g., a $500 bid), tax information (e.g., $20 in tax), and shipping information (e.g., a $30 shipping cost). In turn, the computing device may process the plurality of different candidate financial transactions to identify transactions sufficiently similar to the estimated payment amount of $550. For example, a transaction for $549 might possibly correspond to the auction, whereas a transaction for $30 is extremely unlikely to correspond to the auction.

Moreover, determining there is a matching financial transaction may be based on an estimated maximum of the estimated payment amount. Returning to the example above, pragmatically speaking, it might be extremely unlikely that an item with a bid amount of $500 would correspond to a transaction of over $2,000. After all, that value would suggest that shipping, taxes, and other payments were well over double the price of the bid itself, which would be extremely unlikely. Such a maximum might be determined as a percentage (e.g., that the corresponding transaction is unlikely to be more than 150% of the bid amount), as a dollar value (e.g., that the corresponding transaction is unlikely to be $500 more than the bid amount in circumstances where the bid amount is under $100), or the like. This approach may be particularly useful as a coarse filter of transactions, particularly in circumstances where a quantity of the plurality of different candidate financial transactions is quite large. For example, this approach may be used to filter transactions from the plurality of different candidate financial transactions that are unreasonably large compared to the bid amount.

Additionally and/or alternatively, there is a matching financial transaction may be based on an estimated payment range. Transactions are, for various reasons (e.g., unpredictable shipping costs, currency conversion uncertainties) unlikely to be perfectly predictable. In turn, a range of possible transaction values might be determined based on the estimated payment amount. Such a range might be represented as a percentage (e.g., a range comprising 95% to 105% of the estimated payment amount), a dollar threshold (e.g., a range beginning at the estimated payment amount minus ten dollars and ending at the estimated payment amount plus ten dollars), or the like. In this manner, determining whether there is a matching financial transaction may be based on determining that a difference between a transaction amount and the estimated payment amount satisfies some threshold.

In step 508, and if there is a matching financial transaction found in step 507, the computing device may select the matching financial transaction. For example, the computing device may select, based on the winning bid amount and based on comparing the estimated payment amount to each transaction amount of the plurality of different candidate financial transactions, a first financial transaction of the plurality of different candidate financial transactions.

Step 507 and/or step 508 may comprise use of a machine learning model, such as one implemented via the deep neural network 200 described with respect to FIG. 2. The computing device may train a machine learning model to select a matching financial transaction of the plurality of different candidate financial transactions based on input data comprising, for example, the bid information, the auction information, the account data, and/or the estimated payment amount. To be trained in this manner, the machine learning model may be trained using training data. That training data may comprise a variety of transactions with associated bid information, auction information, account data, and/or estimated payment amounts. That training data may be tagged to indicate whether a transaction is associated with an auction. Then, the trained machine learning model may be provided input data comprising, for example, the bid information, the auction information, the account data, and/or the estimated payment amount. The trained machine learning model may provide, as output, an indication of whether one or more of the plurality of different candidate financial transactions is a matching financial transaction.

As part of step 507 and/or step 508, the computing device may determine whether a transaction has an amount similar to a bid amount. A matching financial transaction need not involve a payment that is exactly identical to the estimated payment amount determined in step 506. Because, for example, the computing device might inaccurately estimate shipping and/or taxes, the amount of a matching transaction may be somewhat different than the estimated payment amount. As such, determining whether there is a matching financial transaction may comprise determining whether an amount of the matching financial transaction is sufficiently similar to the estimated payment amount. For example, the computing device may determine that a difference between a first transaction amount associated with the first financial transaction and the estimated payment amount satisfies a threshold.

Further to the above point, a transaction amount might be lower than a maximum bid amount. For example, a user might be lucky in that they may win an auction for an amount substantially lower than their maximum bid amount. In turn, the computing device may select a transaction even where the transaction is substantially lower than a maximum bid amount. This may be particularly the case where the auction information collected in step 503 indicates that the winning bid amount is lower than the maximum bid amount indicated by the bid information processed in step 502. For example, the computing device may, as part of step 507 and/or step 508, determine that a first transaction amount associated with the first financial transaction is lower than the maximum bid amount.

As part of step 507 and/or step 508, the computing device may evaluate whether a financial transaction is associated with the auction website. In some circumstances, when a user pays for an auction they have won, their payment is processed via the auction website. As such, the transaction may reflect a payment to the auction website, rather than to the actual seller of the one or more item(s) auctioned via the auction website. While this can make correlating a particular payment with a past auction difficult, the merchant indication nonetheless provides strong evidence that a particular transaction was part of an auction. For example, as part of selecting a particular financial transaction, the computing device may determine that the particular financial transaction indicates a merchant associated with the auction website.

As part of step 507 and/or step 508, the computing device may estimate when a user is likely to have paid for the auction. In many circumstances, a user may pay for an auction long after they have placed a bid and, in certain circumstances, long after they have won an auction. As such, as part of determining whether a particular financial transaction is associated with a past bid, the computing device may evaluate the timing of the bid, the timing of the end of the auction, and/or the timing of the particular financial transaction. This process may entail predicting when a user paid for a particular auction. For example, the computing device may determine, based on the auction end time, a predicted payment time associated with the first bid and filter, based on the predicted payment time, the plurality of different candidate financial transactions. This prediction may be based on past payments by one or more users for one or more past auctions.

In some circumstances, a user might implement automatic purchasing of items at auction. In this circumstance, the computing device might estimate when a user is likely to have paid for the auction based on the auction end time. For example, if the computing device determines (e.g., based on the bid information determined in step 502) that the user has implemented automatic payments, then the computing device may estimate that a payment for the auction occurred relatively quickly after (e.g., minutes after) the auction end time. In contrast, if such automatic purchasing is not implemented, then the payment may occur hours (if not day's or even weeks) after the auction end time.

In step 509, the computing device may output an association between the matching financial transaction and the auction. In this manner, the computing device may help a user by indicating, to the user, an association between their subsequent transaction and a bid they placed in the past (and, in turn, an auction that they won). For example, the computing device may output, in a user interface, an association between the first bid and the first financial transaction.

Outputting the association may comprise detailing which item(s) were purchased via the matching financial transaction. It may be useful for a user to indicate which particular item(s) they purchased at auction, along with an indication of the transaction. For example, the computing device may output, in the user interface, at least a portion of the one or more item identifiers. Additionally and/or alternatively, outputting the association may comprise detailing information about the auction, such as the winning bid amount and/or the auction end time determined as part of step 503.

Outputting the association may comprise outputting a confidence value corresponding to the association. The computing device might, as part of step 507 and/or step 508, determine a matching financial transaction with a certain amount of confidence. In turn, outputting the association may comprise indicating this amount of confidence. This may advantageously allow the user to identify circumstances where, for example, the association might not be particularly strong.

In step 510, and if a matching financial transaction was not identified, the computing device may discard cached bid information. This step may be performed in circumstances where a bid does not win, and/or where a user never paid for an auction. For example, the computing device may determine, based on comparing a second estimated payment amount associated with a second bid to each transaction amount of the plurality of different candidate financial transactions, that the second bid is not associated with any of the plurality of different candidate financial transactions. In such a circumstance, the computing device may delete, from storage, second bid information associated with the second bid.

The process depicted in step 503 through step 509 and/or step 510 may be conditioned on the existence of a particular financial transaction. For example, the computing device may be configured to periodically monitor the transactions history database 304 to determine whether a transaction corresponding to an auction website has occurred. Responsive to determining that a transaction corresponding to an auction website has occurred, step 503 through step 509 and/or step 510 may be performed. In other words, rather than letting the impetus for the process depicted in those steps be the end of an auction, the impetus for the process depicted in those steps may be the existence of a particular transaction.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device configured to associate past auction bidding activity with subsequent financial transactions, the computing device comprising:
one or more processors; and
memory storing instructions that, when executed by the one or more processors, cause the computing device to:
receive, from a web browser plugin of a web browser application executing on a user computing device and via a network, at least a portion of content displayed via a Document Object Model (DOM) of the web browser executing on the user computing device, wherein the content is associated with an auction website:
process the content displayed via the DOM to determine bid information indicating a first bid placed by a user on a first auction on the auction website, wherein the bid information comprises:
an auction end time,
a bid amount, and
one or more item identifiers:
after the auction end time has elapsed, determine, via the auction website, auction information that indicates a winning bid amount for the first auction:
receive, from a transactions history database and based on the auction end time, a plurality of different candidate financial transactions conducted by a financial account associated with the user:
receive account data, associated with the financial account, that indicates a location associated with the user:
determine an estimated payment amount based on the bid amount and predicted shipping costs associated with the location:
select, based on the winning bid amount and based on comparing the estimated payment amount to each transaction amount of the plurality of different candidate financial transactions, a first financial transaction of the plurality of different candidate financial transactions; and
output, in a user interface, an association between the first bid and the first financial transaction.

2. The computing device of claim 1, wherein the instructions, when executed by the one or more processors, cause the computing device to select the first financial transaction by causing the computing device to:
determine that a difference between a first transaction amount associated with the first financial transaction and the estimated payment amount satisfies a threshold.

3. The computing device of claim 1, wherein the instructions, when executed by the one or more processors, cause the computing device to determine the estimated payment amount further based on tax information corresponding to the location.

4. The computing device of claim 1, wherein the instructions, when executed by the one or more processors, cause the computing device to select the first financial transaction by causing the computing device to:
determine that the first financial transaction indicates a merchant associated with the auction website.

5. The computing device of claim 1, wherein the instructions, when executed by the one or more processors, cause the computing device to select the first financial transaction by causing the computing device to:
determine, based on the auction end time, a predicted payment time associated with the first bid; and
filter, based on the predicted payment time, the plurality of different candidate financial transactions.

6. The computing device of claim 1, wherein the instructions, when executed by the one or more processors, cause the computing device to:
determine, based on comparing a second estimated payment amount associated with a second bid to each transaction amount of the plurality of different candidate financial transactions, that the second bid is not associated with any of the plurality of different candidate financial transactions; and
delete, from storage, second bid information associated with the second bid.

7. The computing device of claim 1, wherein the instructions, when executed by the one or more processors, cause the computing device to determine the auction information by causing the computing device to:
determine, via the auction website, that a username associated with the user is indicated as winning the auction.

8. The computing device of claim 1, wherein the bid amount comprises a maximum bid amount, and wherein the instructions, when executed by the one or more processors, cause the computing device to select the first financial transaction by causing the computing device to:
determine that a first transaction amount associated with the first financial transaction is lower than a sum of the maximum bid amount, the predicted shipping costs, and tax information corresponding to the location.

9. The computing device of claim 1, wherein the bid information comprises one or more item identifiers, and wherein the instructions, when executed by the one or more processors, cause the computing device to output an association between the first bid and the first financial transaction by causing the computing device to:
output, in the user interface, at least a portion of the one or more item identifiers.

10. A method for associating past auction bidding activity with subsequent financial transactions, the method comprising:
receiving, by a computing device, from a web browser plugin of a web browser application executing on a user computing device, and via a network, at least a portion of content displayed via a Document Object Model (DOM) of the web browser executing on the user computing device, wherein the content is associated with an auction website:
processing, by the computing device, the content displayed via the DOM to determine bid information indicating a first bid placed by a user on a first auction on the auction website, wherein the bid information comprises:
an auction end time,
a bid amount, and
one or more item identifiers:
after the auction end time has elapsed, determining, by the computing device and via the auction website, auction information that indicates a winning bid amount for the first auction:
receiving, by the computing device, from a transactions history database, and based on the auction end time, a plurality of different candidate financial transactions conducted by a financial account associated with the user;
receiving, by the computing device, account data, associated with the financial account, that indicates a location associated with the user:
determining, by the computing device, an estimated payment amount based on:
the bid amount,
predicted shipping costs associated with the location, and
tax information corresponding to the location:
selecting, by the computing device, based on the winning bid amount, and based on comparing the estimated payment amount to each transaction amount of the plurality of different candidate financial transactions, a first financial transaction of the plurality of different candidate financial transactions; and
outputting, by the computing device and in a user interface, an association between:
the first financial transaction, and
at least a portion of the one or more item identifiers.

11. The method of claim 10, wherein selecting the first financial transaction comprises:
determine that a difference between a first transaction amount associated with the first financial transaction and the estimated payment amount satisfies a threshold.

12. The method of claim 10, wherein selecting the first financial transaction comprises:
determining that the first financial transaction indicates a merchant associated with the auction website.

13. The method of claim 10, wherein selecting the first financial transaction comprises:
determining, based on the auction end time, a predicted payment time associated with the first bid; and
filtering, based on the predicted payment time, the plurality of different candidate financial transactions.

14. The method of claim 10, further comprising:
determining, based on comparing a second estimated payment amount associated with a second bid to each transaction amount of the plurality of different candidate financial transactions, that the second bid is not associated with any of the plurality of different candidate financial transactions; and
deleting, from storage, second bid information associated with the second bid.

15. The method of claim 10, wherein determining the auction information comprises:
determining, via the auction website, that a username associated with the user is indicated as winning the auction.

16. The method of claim 10, wherein the bid amount comprises a maximum bid amount, and wherein selecting the first financial transaction comprises:
determining that a first transaction amount associated with the first financial transaction is lower than a sum of the maximum bid amount, the predicted shipping costs, and tax information corresponding to the location.

17. One or more non-transitory computer-readable media storing instructions that, when executed by one or more processors of a computing device, cause the computing device to associate past auction bidding activity with subsequent financial transactions by causing the computing device to:
receive, from a web browser plugin of a web browser application executing on a user computing device and via a network, at least a portion of content displayed via a Document Object Model (DOM) of the web browser executing on the user computing device, wherein the content is associated with an auction website:
process the content displayed via the DOM to determine bid information indicating a first bid placed by a user on a first auction on the auction website, wherein the bid information comprises:
an auction end time,
a bid amount, and
one or more item identifiers:
receive account data, associated with a financial account of the user, that indicates a location associated with the user:
determine an estimated payment amount based on:
the bid amount,
predicted shipping costs associated with the location, and
tax information corresponding to the location;
store the estimated payment amount:
identify, by processing data from a transactions history database, a first financial transaction associated with a merchant associated with the auction website:
compare an amount of the first financial transaction and the estimated payment amount; and
output, by the computing device, based on the comparison, and in a user interface, an association between:
the first financial transaction, and
at least a portion of the one or more item identifiers.

18. The non-transitory computer-readable media of claim 17, wherein the instructions, when executed by the one or more processors, cause the computing device to compare the amount of the transaction and the estimated payment amount by causing the computing device to:
determine that a difference between the amount of the first financial transaction and the estimated payment amount satisfies a threshold.

19. The non-transitory computer-readable media of claim 17, wherein the instructions, when executed by the one or more processors, cause the computing device to determine the estimated payment amount further based on a winning auction amount.

20. The non-transitory computer-readable media of claim 17, wherein the instructions, when executed by the one or more processors, cause the computing device to identify the first financial transaction by causing the computing device to:
query the transactions history database for a merchant identifier associated with the merchant.
